(19) United States
(12) Patent Application Publication
(10) Pub. No.: US 2015/0090028 A1
(43) Pub. Date: Apr. 2, 2015

(54) Atom Interferometry Device for Differential Inertial Measurement

(71) Applicant: ONERA (Office National d'Etudes et de Recherches Aerospatiales), Chatillon (FR)

(72) Inventors: Nassim Zahzam, Palaiseau (FR); Yannick Bidel, Palaiseau (FR); Alexandre Bresson, Palaiseau (FR)

(73) Assignee: ONERA (Office National d'Etudes et de Recherches Aerospatiales), Chatillon (FR)

(21) Appl. No.: 14/388,382

(22) PCT Filed: Mar. 27, 2013
(86) PCT No.: PCT/FR2013/050657

§ 371 Date: Sep. 26, 2014

(30) Foreign Application Priority Data
Mar. 28, 2012 (FR) 1252781

(51) Int. Cl. G21K 1/00; G01C 19/58; G01P 15/08

(52) U.S. Cl. CPC G21K 1/006; G01P 15/08; G01C 19/58
USPC 73/382 R

(57) ABSTRACT

An atom interferometer with differential inertial measurement comprises an atom source system to supply several sets of atoms intended for acceleration measurements which are made simultaneously at different respective locations. The sets of atoms are transported by a dedicated system between an initial position and the locations at which the acceleration measurements are made. The interferometer can be used to obtain highly accurate acceleration or gravity gradient measurement results.

The present invention relates to a device for differential inertial measurement by atom interferometry.

Performing acceleration measurements or gravity field measurements by atom interferometry is known. To this end, cooled atoms are provided by a source of atoms, then are subjected to an acceleration measurement by using an atom interferometry system. The result of the measurement is obtained from a detection of the distribution of the atoms over different atomic states. This result of acceleration or gravity measurement depends on the location where the measurement is carried out, i.e. to the location where the atoms are located at the time of the measurement by atom interferometry.

Performing differential acceleration or gravity measurements is also known, in order to determine spatial variations of the distribution of these fields. To this end, two separate measurements are carried out simultaneously at locations apart from each other, where atomic interferences are produced separately. The precision which is obtained for the value of the acceleration gradient or of the gravity gradient depends on the precision of the two acceleration measurements themselves, and also on the precision with which the distance of separation between these measurement locations is known. In particular, this precision is improved when the separation distance is increased between the two locations where the simultaneous acceleration measurements are carried out.

Moreover, a need exists for devices which are capable of measuring spatial variations of acceleration or gravity, called gradiometers, which are compact and inexpensive, while providing gradient measurement results with a precision as high as possible.

The article entitled “Sensitive absolute-gravity gradiometry using atom interferometry”, by J. M. McGuirk et al., Physical Review A, vol. 65, 033608 (2002), describes a gradiometer which is constituted by two separate sources of cold atoms, which are arranged so as to separately supply atoms to separate atom interferometry systems. Each source of atoms is individually dedicated to one of the atom interferometry systems. In this way, the interferometry systems can be apart from one another with a significant separation distance, for example of the order of 1 m (metre), so that the distance between the locations of the acceleration measurements which are performed simultaneously is known with a high relative precision. But such a design of gradiometer is complex and expensive, as it comprises two independent sources of cold atoms.

Another drawback of such a system with two sources of atoms which are separate, results from the possible existence of a difference between initial velocities of the atoms which are produced respectively by the two sources. Such a difference may result in particular from a difference between the intensities of the laser beams which are used for cooling the atoms separately in each of the sources. It is difficult to precisely control one with respect to one another the two intensities of the laser beams which are used for cooling. This difference between the initial velocities then causes a bias in the difference between the results of the acceleration measurements which are obtained for each set of atoms. Moreover, this bias may fluctuate over time, because of a possible drift in the intensities of the laser beams used for cooling.

The article which is entitled “102hk large area atom interferometers”, by S. Chiow et al., Physical Review Letters, vol. 107, 130403 (2011), describes how to simultaneously produce two acceleration measurements by using two different atom interferometers which are supplied with atoms from one and the same source of cold atoms. In this way, the bias which could be caused by a difference between the initial velocities of atoms which originate from separate sources is prevented. To this purpose, in the system of S. Chiow, a single initial cluster of atoms which is supplied by the source is separated into two separate sets, by transferring a kinetic pulse to certain atoms by several multiphoton Bragg sequences of absorption and emission. The precision with which the acceleration gradient can be calculated is then limited by the short separation distance between the two locations where the acceleration is measured. In fact, this separation distance is at maximum of the order of 600 μm (micrometre).

The article by Yu et al., which is entitled [symbol] Development of an atom-interferometer gravity gradiometer for gravity measurement from space [symbol] , Applied Physics B, Lasers and Optics, Springer, Berlin, Del., vol. 84, No. 4, 18 Jul. 2006, pages 647-652, relates to another atom gradiometer which is constituted by two accelerometers each with an atomic fountain configuration. Such a device comprises two separate systems of atom sources from which respectively originate the sets of atoms on which the measurements are simultaneously carried out.

The article by Lamporesi et al., which is entitled “Determination of the Newtonian Gravitational Constant Using Atom Interferometry”, Physical Review Letters, vol. 100, No. 5, 1^{st} February 2008, 050801, describes a gradiometer which comprises only a single source of atoms, but in which two sets of atoms are placed at the measurement locations by a sequence of launches and recapture of these sets of atoms. The two sets of atoms on which the simultaneous measurements are carried out are thus produced successively by the source of atoms. They may then still have a difference in their initial velocities, producing a measurement bias in the differential acceleration results which are obtained by using such a gradiometer.

Finally, the article by Schmid et al., which is entitled “Long distance transport of ultracold atoms using a 1D optical lattice”, New Journal of Physics, vol. 8, No. 8, 1^{st} August 2006, pages 156-159, relates to the theoretical principle of systems for transporting atoms by optical lattices.

Under these conditions, a first object of the invention consists in providing a new configuration of gradiometer, which allows the device to be compact, simpler, and with a lower cost.

A second object of the invention consists in providing a gradiometer capable of providing highly accurate acceleration or gravity gradients values. In particular, an object of the invention is to reduce or prevent the bias which may affect the result of the difference between the accelerations which are measured simultaneously, and which results from a possible difference in the initial velocities of the atoms which are used for each of the measurements.

To this end, the invention proposes a differential inertial measurement device, or gradiometer, which comprises:
an atom source system, which is arranged to supply atoms for acceleration measurements; and
at least one atom interferometry and detection system, arranged to provide results of acceleration measurements which are carried out simultaneously for several separate sets of atoms when these sets of atoms are situated in respective measurement zones which are apart from one another.

Each acceleration measurement result is associated with a position of the measurement zone for the set of atoms which has been used for this acceleration measurement, in order to obtain a differential inertial measurement result.

According to a first feature of the invention, the atom source system is adapted for producing a cluster of atoms which is intended to be divided into several sets of atoms.

According to a second feature of the invention, the device further comprises:
at least one atom transport system, which is arranged in order to move at least one of the sets of atoms, after division of the cluster of atoms, so that the sets of atoms are each situated in the corresponding measurement zone after an operation of the atom transport system.

Thus the atoms which are used for two of the acceleration measurements which are carried out simultaneously in the measurement zones apart from each other originate from the same cluster of atoms, and form the two separate sets of atoms which are situated in the corresponding measurement zones.

Within the context of the present invention, by “atom transport system” is meant a means of for moving atoms which allows atoms to be captured in their initial position, then to subsequently release them in a final position. To this end, the atom transport system produces an acceleration of the atoms from their initial position, can hold the atoms with a determined velocity for a duration which is also controlled, then slow the atoms down in order to place them in the final position. Usually, but without this being essential, the atoms may have a zero or very low velocity, in their initial position and/or in their final position, at the start and/or at the end of the use of the atom transport system.

Thanks to the use of such an atom transport system, the atoms which are used to carry out the simultaneous acceleration measurements at separate locations, may be provided by the same source of cold atoms. In this way, the device of the invention may comprise only a single source of atoms, which simplifies its design, makes it more compact and reduces its cost.

Moreover, thanks to the fact that the sets of atoms which are used for the simultaneous acceleration measurements, originate from the same initial cluster, the difference is zero between the respective initial velocities of the atoms which belong to the separate sets. Thus, the acceleration measurement difference bias which could result from such difference in the initial velocities is suppressed by the invention.

In addition, the atom transport system may be adapted for transporting at least one of the sets of atoms with a significant path length, for example several tens of centimetres, and possibly more than 1 metre. This length is known with precision from the control of the atom transport system, so that the acceleration or gravity gradient can be calculated with precision from the results of the acceleration measurements which are obtained for the different sets of atoms.

Advantageously, each atom transport system may be adapted in order to produce optical lattices which are each capable of trapping one of the sets of atoms, so as to continually impose a position on this set of atoms over an operation duration of the transport system. Indeed, an optical lattice is constituted by two progressive monochromatic electromagnetic waves, of laser type, which are superimposed and propagate in opposite directions. The displacement of the atoms is then controlled by adjusting a difference between the respective frequencies of the two progressive waves. The techniques which are currently available for varying and controlling the frequency of a monochromatic wave make it possible to very precisely and simply control the position of the atoms which are transported.

In different embodiments of the invention, the device can have a configuration such as:
one of the optical lattices is fixed in order to keep one of the sets of atoms at a fixed location, and another one of the optical lattices is mobile in order to move another one of the sets of atoms between determined initial and final positions; or
the two optical lattices are mobile, and each arranged for moving one of the sets of atoms between determined initial and final positions. In this case, the two mobile optical lattices may advantageously be adapted so that each moves one of the sets of atoms in opposite moving directions along in a common straight line.

In improvements of the invention, the differential inertial measurement device may comprise a laser source unit which is adapted for producing a laser beam over a constant beam path, and a control unit which is capable of successively controlling the laser source unit according to different operating modes. These modes may comprise:
a first operating mode, in which the laser source unit forms at least one of the optical lattices, this optical lattice being adapted for moving one of the sets of atoms or keeping it in a fixed position; and
a second operating mode, in which the laser source unit forms a Raman source which is adapted for causing a sequence of successive two-photon interactions with the atoms, in order to produce an atomic wave interference;
optionally a third operating mode, in which the laser source unit participates in forming a magneto-optical trap of the atom source system, adapted for cooling the atoms, and
optionally a fourth operating mode, in which the laser source unit produces a splitting pulse which is suitable for forming the separate sets of atoms by dividing a single initial cluster of atoms supplied by the atom source system.

Finally, the invention also proposes a method for measuring an acceleration or gravity gradient, which is implemented by using a differential inertial measurement device as described previously.

Other features and advantages of the present invention will become apparent from the description below of non-limitating implementation examples, with reference to the attached drawings, in which:

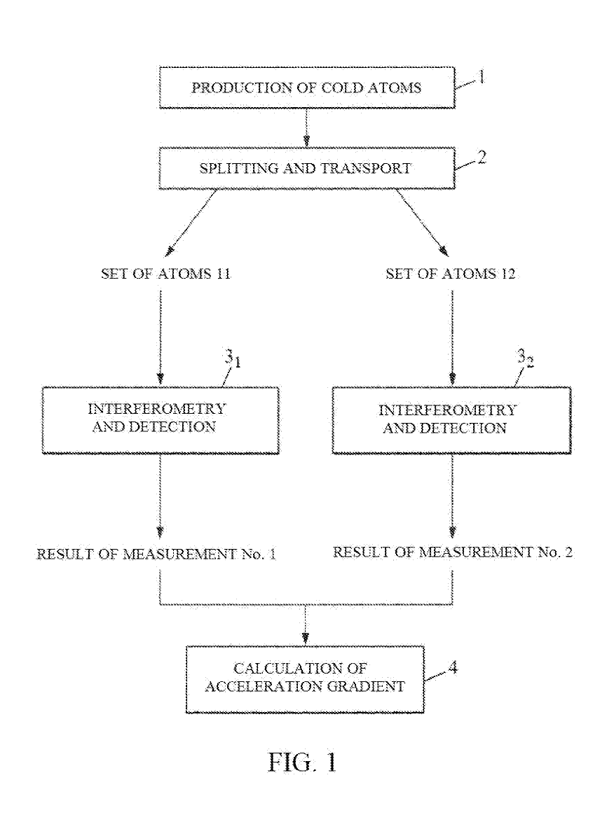

FIG. 1 is an operating diagram of the steps of a differential inertial measurement which is carried out by using a device according to the invention;

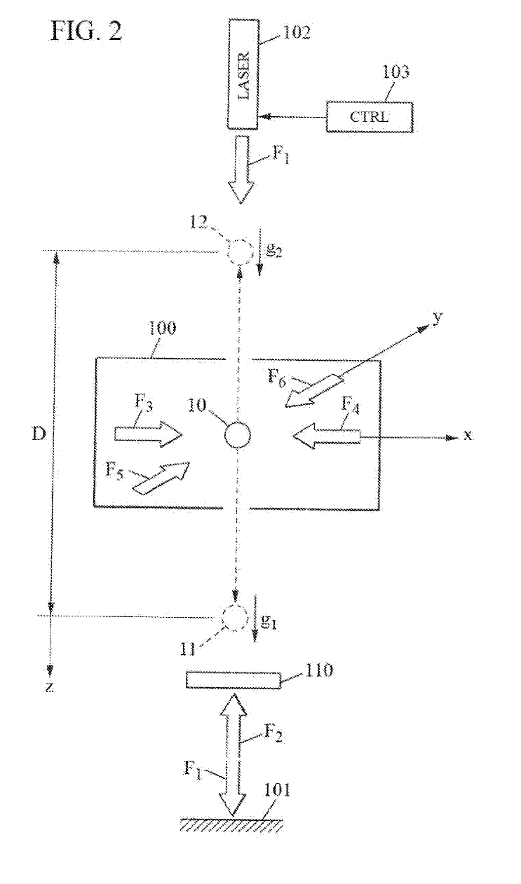

FIG. 2 diagrammatically represents a possible configuration of a differential inertial measurement device according to the invention; and

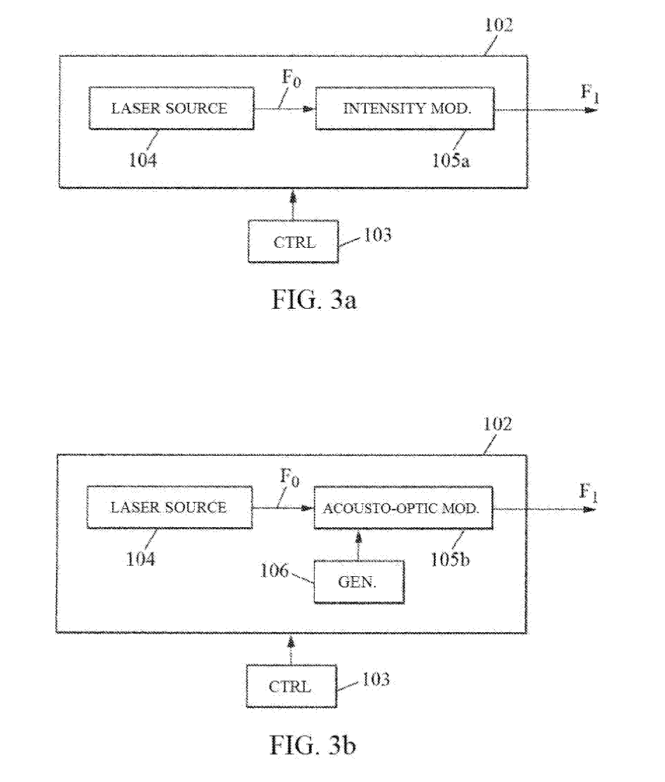

FIGS. 3a and 3b respectively show two possible ways of constituting a laser source unit, for possible use in a differential inertial measurement device according to the invention.

For reasons of clarity, the dimensions of the elements which are represented in these figures correspond neither to actual dimensions nor to actual dimensional relationships. Moreover, identical references which are indicated in different figures designate identical elements or those which have identical functions.

With reference to FIGS. 1 and 2, a single source 100 is used in order to produce a cluster of cold atoms 10 which is intended to be divided into several sets of atoms, the latter being conveyed to locations which are spatially separate in order to simultaneously carry out acceleration measurements in each of these locations. The step of producing the cluster of atoms 10 is referenced 1 in FIG. 1. By way of illustration and simplification, but non-limitatively, the present description is restricted hereinafter to the case where two sets of atoms 11 and 12 are produced by the division of the cluster 10, for simultaneously carrying out two acceleration measurements and deducing therefrom an acceleration gradient value. This acceleration gradient can be a gravity gradient when the atoms are subjected to the gravity field.

The function of the source 100 is to trap the atoms of the cluster 10 and cool them down to a determined temperature. It may have one of the structures known to a person skilled in the art, such as a magneto-optical trap. Such a trap comprises a pair of coils (not shown) in an anti-Helmholtz configuration, which are supplied with electric current during a first phase of operation of the trap in order to create a magnetic field gradient at the location at which the cluster 10 is kept. Three pairs of laser beams cross at this location, propagating in opposite directions for two beams of the same pair. Thus, the beams F₁ and F₂ propagate in opposite directions along the z-axis, the beams F₃ and F₄ along the x-axis and the beams F₅ and F₆ along the y-axis. Different methods of forming beams F₁-F₆, in particular by using reflecting mirrors to reduce the number of laser sources which are necessary, are known and need not be repeated. In a second phase of operation of the magneto-optical trap, the magnetic field gradient is suppressed and the radiation frequencies of the laser beams are detuned in order to obtain a cloud of cold atoms, called a molasse, which has a sub-Doppler temperature.

The atoms of the cluster 10 are then loaded into an atom transport system which conveys them by separate sets to the locations of the acceleration measurements. The atom transport system may be constituted by several optical lattices which are created at the initial location of the cluster of atoms 10 and can extend at least to the locations of the acceleration measurements.

In a known fashion, an optical lattice may be constituted by two laser waves which have approximately equal radiation intensities, are superimposed and propagate in opposite directions, such as the beams F₁ and F₂ in FIG. 2. When the radiation frequencies of the laser beams F₁ and F₂ are equal, they form a stationary wave along the z-axis, which is constituted by an alternating pattern of nodes and antinodes of the electric field. In a known fashion, each antinode or each node of the electric field forms a potential well for the atoms, which is capable of spatially confining them, in other words trapping them. The lattice is then a fixed optical lattice. When one of the two laser beams has a frequency a little different from that of the other one, the stationary wave structure moves along the z-axis, in a constant direction if the frequency difference itself has a constant sign. The potential wells which contain atoms then transport them according to the displacement of the optical lattice, in a way that is controlled by the difference between the radiation frequencies of the two laser beams. The optical lattice which is thus obtained is mobile, and is commonly called an optical lift.

For the atoms which are initially situated at the location of a potential well of the optical lattice not to leave this well, it may be advantageous to further reduce the initial velocity of the atoms of the cluster 10 so that their escape from the optical lattice is no longer possible. To this purpose, a phase of additional cooling, called sub-recoil cooling, may be carried out. Such sub-recoil cooling of the atoms can be carried out by using for example the Raman cooling technique which is described in the article entitled “Laser cooling below a photon recoil with three-level atom”, by M. Kasevich et al., Physical Review Letters, vol. 69, pp. 1741-1744 (1992), or the cooling technique by sidebands which is described in the article entitled “Degenerate Raman sideband cooling of trapped caesium atoms at very high atomic densities”, by V. Vuletić et al., Physical Review Letters, vol. 81, pp. 5768-5771 (1998). Alternatively, the atoms can be selected as a function of their velocity, for example by using a Raman pulse. One such selection method is described in the article entitled “Atomic velocity selection using stimulated Raman transitions”, by M. Kasevich et al., Physical Review Letters, vol. 66, pp. 2297-2300 (1991). This method can be implemented by using a laser source unit modulated for the beams F₁ and F₂ as described below, beam F₂ being obtained by retroreflection of beam F₁ on the reflecting mirror 101 (FIG. 2). The atoms which are not selected by the Raman pulse are then ejected by a laser beam which is tuned so as to be in resonance with a quasi-closed atomic transition. However, such cooling of the atoms or such a selection as a function of their velocity is not indispensable, and the optical lattices may be turned on directly after the optical molasse is obtained. The atoms which are not trapped in the fundamental band of the optical lattices will be lost spontaneously, during the acceleration or deceleration phases of the optical lattices.

Several combinations of optical lattices can be used alternately, in order to leave two sets of atoms 11 and 12 respectively in final positions which are separated from one another and known with precision. Indeed, depending on the control of each optical lattice using the radiation frequencies of the laser beams of which it is constituted, the distance over which the atoms are transported by the optical lattice is known precisely. Among the possible combinations, there can be mentioned:
an optical lattice which is fixed in order to keep one of the sets of atoms at the location of the initial cluster 10, and another optical lattice which is mobile in order to move the other set of atoms from the location of the initial cluster 10 to a final position where, or close to which, the acceleration will be measured; and
two mobile optical lattices, for example one for moving the set of atoms 11 in the direction of the z-axis, and the other for moving the set of atoms 12 in the opposite direction.

Such optical lattices can be produced in many ways.

According to a first way, the device may comprise, for at least one of the optical lattices, two laser sources which are arranged so as to respectively produce the two laser beams which are superimposed and propagate in opposite directions. A control unit is then adapted to vary the respective radiation frequencies of the laser sources, so as to control a displacement of the optical lattice.

The second way which is described now provides a simplified configuration of the device. As represented in FIG. 2, the device may comprise a laser source unit 102 and also the mirror 101, which are arranged so that the laser beam which is produced by the laser source unit 102 is reflected by the mirror 101 in order to form an incident beam and a reflected beam. F₁ and F₂ therefore again designate the incident and reflected beams which are superimposed and propagate in opposite directions. A control unit 103, denoted CTRL, is then arranged to vary the respective radiation frequencies of components of the laser beam, one of these components in the incident beam F₁ forming one of the optical lattices with one of the components in the reflected beam F₂.

In order to vary the radiation frequencies of the components of the laser beam, the laser source unit 102 may include one of the following modulation systems:
a radiation intensity modulator; or
a acousto-optic modulator which is arranged to receive an acoustic signal, and adapted for modulating a frequency of an optical radiation which passes through this modulator, as a function of the acoustic signal.
   The modulation system used is arranged so as to modulate the laser beam before forming the incident F₁ and reflected F₂ beams of the optical lattices.

FIG. 3a shows the structure of the laser source unit 102 when a radiation intensity modulator is used. The unit 102 then comprises a laser source 104 which produces an initial laser beam F₀, the radiation frequency of which is f₀. The intensity modulator 105a, denoted INTENSITY MOD., receives the initial beam F₀ at the input and produces the modulated beam F₁ at the output. When the modulation is controlled by the control unit 103 according to a modulation frequency f₁, the beam F₁ mainly has three components the respective radiation frequencies of which are f₀, f₀+f₁ and f₀−f₁. By using the mirror 101 in order to form the reflected beam F₂, two mobile optical lattices in the same direction parallel to the z-axis result from the interference between the frequency component f₀ in the beam F₁ and the frequency component f₀+f₁ in the beam F₂, and between the frequency component f₀−f₁ in the beam F₁ and the frequency component f₀ in the beam F₂, and two other mobile optical lattices in the opposite direction result from the interference between the frequency component f₀+f₁ in the beam F₁ and the frequency component f₀ in the beam F₂, and between the frequency component f₀ in the beam F₁ and the frequency component f₀−f₁ in the beam F₂. These two optical lattices move simultaneously with absolute displacement velocities which are equal.

FIG. 3b corresponds to FIG. 3a when an acousto-optic modulator is used. The unit 102 also comprises the laser source 104, the acousto-optic modulator 105b, denoted ACOUSTO-OPTIC MOD., and a modulation generator 106, denoted GEN. The modulation generator 106 transmits a modulation signal to an acoustic signal input of the modulator 105b. The modulation signal may be composed of two RF waves of respective frequencies which are different, so that the mobile lattices which are created can move at velocities which are themselves different from one another.

At the same time, due to the use of the mirror 101, one or more fixed optical lattices are produced, superimposed on the desired mobile optical lattices. Atoms of the initial cluster 10 may thus be lost due to these unwanted lattices, without such loss affecting the operation of each acceleration measurement. However, further development of the atom transport system allows such a loss of atoms to be avoided. According to this development, the laser source unit 102 may be adapted for producing two monochromatic components of the laser beam with respective radiation frequencies which are different, and with respective directions of linear polarization which are perpendicular to one another in the incident beam F₁. For example, the first component has the radiation frequency v and a linear polarization which is parallel to the x-axis in the incident beam F₁, and the second component has the radiation frequency v+Δv and a linear polarization which is parallel to the y-axis also in the incident beam F₁. The device then further comprises a quarter-wave plate 110 which is arranged in front of the mirror 101, and which is effective for the two components of the laser beam in incident F₁ and reflected F₂ beams. Due to the transformations of polarization which are produced by the quarter-wave plate 110, the wave field in which the cluster of atoms 10 is found comprises only a first optical lattice which is polarized along the x-axis and a second optical lattice which is polarized along the y-axis. The two optical lattices have instantaneous displacement velocities which are equal, directed in opposite directions parallel to the z-axis, and controlled by the frequency difference Δv.

Several methods may be used for dividing the initial cluster of atoms 10 into two, then for transporting the two sets of atoms 11 and 12 which are thus created to their final acceleration measurement positions. Among these methods, there can be mentioned non-limitatively:
starting from the initial position of the cluster 10 as it is produced by the magneto-optical trap 100, the atoms may firstly be kept in place by a fixed optical lattice if they are produced with a zero initial velocity. If this initial velocity is not zero, they may be optically decelerated beforehand. Then, two mobile optical lattices may be generated as described previously, for accelerating then slowing down the sets of atoms 11 and 12 in the two opposite directions along a common straight line, so as to convey them into the final positions for acceleration measurement;
the division of the cluster 10 in order to form the two sets of atoms 11 and 12 may be carried out by using an optical splitting sequence with two simultaneous Raman pulses which have opposite effective wave vectors. Such a splitting sequence is described for example in the article entitled “Enhancing the area of a Raman atom interferometer using a versatile double-diffraction technique”, by T. Lévèque et al., Physical Review Letters, vol. 103, 080405 (2009). The two sets of atoms 11 and 12 which then have opposite momenta are next loaded into two mobile lattices which move in opposite directions;
the division of the cluster 10 may also be carried out by firstly cooling the atoms or by selecting a part of them as a function of their velocity, then by using a Bragg pulse as optical splitting sequence, in order to divide the cluster 10 into two sets of atoms 11 and 12. The Bragg pulse is constituted by a pulsed optical lattice which interacts with certain atoms without causing an electronic transition thereof, unlike a splitting sequence with a Raman pulse. Two optical lattices are then produced: one for transporting the atoms which have interacted with the Bragg pulse, and the other for the atoms which have not undergone this interaction. Such a method is described for example in the article entitled “A Bose-Einstein condensate in an optical lattice”, by Hecker Denschlag et al., Journal of Physics B, vol. 35, 3095 (2002); or
more simply, the splitting sequence may be a single Raman laser pulse, and those atoms which have undergone the Raman transition are loaded into a mobile optical lattice, while those which have not undergone the Raman transition are trapped in a fixed optical lattice.

In FIG. 1, the step of splitting and transport of the sets of atoms 11 and 12 is referenced 2. At the end of this step, the sets of atoms 11 and 12 are situated at locations in the device which are known with precision. In FIG. 2, the two locations are apart from one another with the separation distance D.

The interferometric acceleration measurements 3₁ and 3₂ are then carried out simultaneously for the two sets of atoms 11 and 12, at the locations in which the latter are situated at the end of the splitting and transport step 2. Each of the two interferometers implements a sequence of stimulated Raman pulses between the two hyperfine ground states of the atoms of the corresponding assembly 11 or 12. Several sequences of Raman pulses can be used alternately, including the one which is described in the article entitled “Atomic interferometry using stimulated Raman transitions”, by M. Kasevitch et al., Physical Review Letters, vol. 67, pp. 181-184 (1991) set out below:
a first Raman pulse, called π/2 pulse and having a splitting function;
a second Raman pulse, called π and having an atom mirror function; then
a third Raman pulse, again π/2 and having a function of recombining the atomic wave packets.

Advantageously, a single Raman beam can be used to carry out the acceleration measurements on the two sets of atoms 11 and 12, in order to efficiently suppress the measurement noise which could affect the two interferometric measurements differently.

Each interferometric measurement then proceeds by detection of the corresponding proportion of the atoms of the corresponding set which are in one of the two hyperfine ground states. Several different techniques are known to a person skilled in the art for carrying out such a detection. For example, this may be a light-absorption measurement, with pulses having a wavelength selected so as to cause an absorption from only one of the hyperfine atomic states.

Results of the acceleration measurements denoted g₁ and g₂ are thus obtained respectively for the two sets of atoms 11 and 12, and the acceleration gradient can be calculated in step 4 by dividing the difference of these results by the distance of separation D: (g₁−g₂)/D.

According to a preferred configuration of a device according to the invention, the same laser source unit 102 can be used repeatedly for different functions, which are implemented successively in the differential inertial measurement device. The functions concerned can be:
cooling of the atoms of the initial cluster 10 in step 1;
division of the cluster 10 in order to form the sets of atoms 11 and 12, at the start of step 2;
production of the optical lattices for the transport of the separate sets of atoms 11 and 12, in step 2; and
production of the Raman pulses in order to create the atomic wave interferences, for the two sets of atoms 11 and 12 respectively in steps 3₁ and 3₂.

In particular, the configuration of the device described in the article [symbol] A cold atom pyramidal gravimeter with a single laser beam [symbol] , by Q. Bodart et al., Applied Physical Letters, vol. 96, 134101 (2010), may be implemented. The magneto-optical traps and the atom interferometer are produced by using a single laser source unit, which provides a simplified and very compact structure for the device. In order to obtain a gradiometer according to the present invention, this same laser source unit may also be used again for dividing the initial cluster of atoms and producing the optical lattices. The cluster of cold atoms 10 then leaves the pyramidal reflector zone by free fall. It is then transferred into a mobile lattice in order to slow down the atoms to zero velocity. Once stopped in this way, the atoms of the cluster 10 are divided in order to form the two sets 11 and 12 then transported to the locations of the acceleration measurements as described above.

It is understood that the present invention may be reproduced while modifying certain aspects with respect to the detailed description which has been provided. In particular, the directions in which the atoms are transported, between the output of the source of cold atoms and the performing of the acceleration measurements by interferometry, may be changed. Similarly, it is also possible to change the relative orientation of the direction of separation of the sets of atoms which are used for the acceleration measurements, with respect to the direction of the component of acceleration which is measured. Thus, the invention can be applied for measuring some or all of the terms of the gravity gradient tensor. Finally, the invention may be reproduced using atom transport systems other than optical lattices.

1. A differential inertial measurement device, comprising:
an atom source system, arranged to supply atoms for acceleration measurements;
at least one atom interferometry and detection system, arranged to provide results of acceleration measurements carried out simultaneously for several separate sets of atoms when said sets of atoms are situated in respective measurement zones apart from one another,
each acceleration measurement result being associated with a position of the measurement zone for the set of atoms which has been used for said acceleration measurement, in order to obtain a differential inertial measurement result,
wherein the atom source system is adapted for producing a cluster of atoms intended to be divided into several sets of atoms; and
at least one atom transport system, which is arranged in order to move at least one of the sets of atoms, after division of the cluster of atoms, so that the sets of atoms are each situated in the corresponding measurement zone after an operation of the atom transport system,
so that the atoms which are used for two of the acceleration measurements carried out simultaneously in the measurement zones apart from each other originate from the same cluster of atoms, and form the two separate sets of atoms which are situated in the corresponding measurement zones.

2. The device according to claim 1, in which the atom transport system is adapted for producing optical lattices each capable of trapping one of the sets of atoms, so as to continually impose a position on said set of atoms over an operation duration of the transport system.

3. The device according to claim 2, in which one of the optical lattices is fixed in order to keep one of the sets of atoms at a fixed location, and another one of the optical lattices is mobile in order to move another one of the sets of atoms between determined initial and final positions.

4. The device according to claim 2, in which two of the optical lattices are mobile, and each arranged for moving one of the sets of atoms between determined initial and final positions.

5. The device according to claim 4, in which the two mobile optical lattices are adapted for each moving one of the sets of atoms in opposite moving directions along a common straight line.

6. The device according to claim 2 comprising, for at least one of the optical lattices, two laser sources arranged so as to respectively produce two superimposed laser beams propagating in opposite directions, and a control unit adapted to vary respective radiation frequencies of the laser sources, so as to control a shift of the optical lattice.

7. The device according to claim 2 comprising a laser source unit and a mirror arranged so that a laser beam produced by the laser source unit is reflected by the mirror in order to form an incident beam and a reflected beam, superimposed and propagating in opposite directions, the device also comprising a control unit arranged in order to vary the respective radiation frequencies of components of the laser beam, one of the components in the incident beam forming one of the optical lattices with one of the components in the reflected beam.

8. The device according to claim 7, in which the laser source unit includes
a radiation intensity modulator
being arranged in order to modulate the laser beam before forming said incident and reflected beams of the optical lattices.

9. The device according to claim 7 in which the laser source unit is adapted for producing two components of the laser beam with respective radiation frequencies which are different,
the two laser beam components having respective directions of linear polarization which are perpendicular to one another in the incident beam, and
the device further comprising a quarter-wave plate arranged in front of the mirror, and effective for the two components of the laser beam in the incident and reflected beams.

10. The device according to claim 7 in which the laser source unit is adapted for producing the laser beam over a constant beam path, and the control unit is capable of successively controlling the laser source unit according to the different operating modes, in which
for a first operating mode, the laser source unit forms at least one of the optical lattices adapted for moving one of the sets of atoms or keeping one of the sets of atoms in a fixed position; and
for a second operating mode, the laser source unit forms a Raman source which is adapted for causing a sequence of successive two-photon interactions with the atoms, in order to produce an atom wave interference.

11. The device according to claim 10, in which the control unit is further adapted for controlling the laser source unit according to at least one of the following additional operating modes:
for a third operating mode, the laser source unit participates in forming a magneto-optical trap of the atom source system, adapted for cooling the atoms, and
for a fourth operating mode, the laser source unit produces a splitting pulse suitable for forming the separate sets of atoms by dividing one and the same initial cluster of atoms supplied by the atom source system.

12. A method for measuring an acceleration or gravity gradient, implemented by using a device according to claim 1.

13. The device according to claim 7, in which the laser source unit includes an acousto-optic modulator arranged in order to receive an acoustic signal, to modulate a frequency of an optical radiation passing through said modulator as a function of the acoustic signal, and to modulate the laser beam before forming said incident and reflected beams of the optical lattices.
